(19) United States
(12) Patent Application Publication
(10) Pub. No.: US 2014/0117007 A1
(43) Pub. Date: May 1, 2014

(54) Local Heat Treatment and Thermal Management System for Engine Components

(71) Applicant: GENERAL ELECTRIC COMPANY, Schenectady, NY (US)

(72) Inventors: Timothy J. Trapp, Wyoming, OH (US); Thomas Froats Broderick, Springboro, OH (US); Jeffrey Root, Columbus, OH (US); Greg Firestone, Pickerington, OH (US)

(73) Assignee: General Electric Company, Schenectady, NY (US)

(21) Appl. No.: 13/663,125

(22) Filed: Oct. 29, 2012

(51) Int. Cl. H05B 6/02; H05B 6/36

(52) U.S. Cl. CPC H05B 6/02; H05B 6/36
USPC 219/601; 219/602

(57) ABSTRACT

A method of heat treating an engine component includes connecting a disk having a plurality of titanium components to a fixture, positioning one of the titanium components into an induction coil loop, providing an alternating current to the induction coil loop, heat treating the titanium component positioned in the induction coil loop and, monitoring a temperature of the heat treating.

### CROSS-REFERENCE TO RELATED APPLICATIONS

None.

### BACKGROUND

The disclosed embodiments generally pertain to thermal management and heat treatment of turbine engine components. More particularly present embodiments pertain to methods for localized thermal management and heat treatment for engine components.

In a gas turbine engine, air is pressurized in a compressor and mixed with fuel in a combustor for generating hot combustion gases, which flow downstream through turbine stages. These turbine stages extract energy from the combustion gases. A high pressure turbine first receives the hot combustion gases from the combustor and includes a stator nozzle assembly directing the combustion gases downstream through a row of high pressure turbine rotor blades extending radially outwardly from a supporting rotor disk. In a two stage turbine, a second stage stator nozzle assembly is positioned downstream of the first stage blades followed in turn by a row of second stage rotor blades extending radially outwardly from a second supporting rotor disk. This results in conversion of combustion gas energy to mechanical energy.

The first and second rotor disks are coupled to the compressor by a corresponding high pressure rotor shaft for powering the compressor during operation. A multi-stage low pressure turbine may or may not follow the multi-stage high pressure turbine and may be coupled by a second shaft to a fan disposed upstream from the compressor.

As the combustion gas flows downstream through the turbine stages, energy is extracted therefrom and the pressure of the combustion gas is reduced. The combustion gas may continue through multiple low stage turbines. This rotates the shafts which in turn rotates the one or more compressor.

The compressor, turbine and the bypass fan may have similar construction. Each may have a rotor assembly including a rotor disc and a set of blades extending radially outwardly from the rotor disc. The compressor, turbine and bypass fan share this basic configuration. However the materials of construction of the rotor disc in the blades as well as shapes and sizes of the rotor discs and blades vary in these different sections of the gas turbine engine. The blades may be integral with and metallurgically bonded to the disk. This type structure is called a blisk (“bladed disk”). Alternatively, the blades may be mechanically attached to the disk, such as by dovetail connection. Alternative to disks, drums may be utilized.

During operation, it becomes necessary to periodically repair engine components, such as for example, blades, case, frame, and/or blisk in local areas. For example, turbine and compressor blades may receive foreign object damage, such as by entrained particles in the gas flow that impinge the blade, over a period of time of service. Other sources of damage include tip rubbing, oxidation, thermal fatigue cracking, and erosions from the sources described above. Eventually, portions of the blade may need replacement. Sometimes this requires replacement of a tip portion. Other times, larger portions of the blade must be replaced. Since only limited segments of the blades typically have foreign object damage, it is desirable to replace only the sections containing the damage.

One problem with replacement of portions of workpieces or engine components is that the existing portions of the component and the disk or drum become heat sinks when the replacement portion of the workpiece or engine component is welded on. This can change the metallurgy of the existing components and the disk or drum in area away from the weld area, which is highly undesirable. For example, when titanium based metal are used, they may also form alpha case on the surface of the metal. For example, heating of certain materials over approximately 315 degrees C. (600 degrees F.) may result in development of a brittle layer of undesirable build up on the component, for example alpha case. Advanced engine components have critical dimensions, that may be altered or damaged by heat treatments of the entire component. This alpha case then must be removed by chemical processing, which removes metal from the part. This can result in change in tolerances in parts rendering them unsuitable for use.

After the replacement part is welded on, the replacement part may also need to be heat treated to relieve stress. However, it is desirable that heat application or exposure does not cause damage or weakening of the previously undamaged portions of the airfoil. This local treatment is more desirable than subjecting the entire part to thermal cycles.

One problem with known local heat treatment methods is that process control methods have been lacking. As a result, the components may be over heated or under heated. The use of local heat treatment has been limited.

It would be desirable to reduce or eliminate these and other problems associated with in situ localized welding and subsequent heat treatment.

It is further desirable that surface oxidation or alpha case formation be limited and that repaired components maintain stringent requirements of dimensional accuracy, microstructure, and mechanical performance for example.

### SUMMARY

According to at least one embodiment, A method of thermal management for engine components comprises positioning an engine component in at least one tool, positioning a first tool section on the engine component, positioning a second tool section on the engine component, heating a localized area of said engine component with at least one heater block, passing a cooling fluid to cooling portions of the first and second tool sections away from the area of the workpiece being heat treated, limiting heat dissipation through the workpiece with the cooling fluid, managing cooling time of the heat treatment of the workpiece.

According to an alternate embodiment, a method of thermal management, comprises positioning a first workpiece and a second workpiece in at least one tool having internal cavities, passing a fluid into at least one of the internal cavities to cool portions of the first and second workpieces, welding the first workpiece and the second workpiece in the at least one tool by resistance heating to form a joined workpiece, controlling a rate of cooling of the joined workpiece to slow a rate of cooling through at least one of a resistive heat element or welding electrode of the at least one tool.

According to still an further embodiment, a localized thermal management tool, comprises a mounting block, a first heater block having a first workpiece engagement surface, a second heater block having a second workpiece engagement surface, a resistive heater mounted within at least one of the first heater block and the second heater block, a first cooling clamp engaging the mounting block and the first heater block, a second cooling clamp engaging the mounting block and the second heater block, a cooling fluid conduit disposed in at least one of the first and second cooling clamps, an insulator between each of the heater blocks and the cooling clamps.

According to further embodiments, a method of heat treating an engine component comprises welding a first portion of an engine compartment on a second portion of said first portion of said engine component, positioning the engine component in a fixture at a heat treatment station, positioning at least one of the first portion and the second portion in an induction coil, applying current to the coil and, heat treating the at least one of the first portion and the second portion.

According to even further embodiments, a method of heat treating an engine component comprises connecting a disk having a plurality of titanium components to a fixture, positioning one of the titanium components into an induction coil loop, providing an alternating current to the induction coil loop, heat treating the titanium component positioned in the induction coil loop and, monitoring a temperature of the heat treating.

### BRIEF DESCRIPTION OF THE ILLUSTRATIONS

Embodiments of the invention are illustrated in the following illustrations.

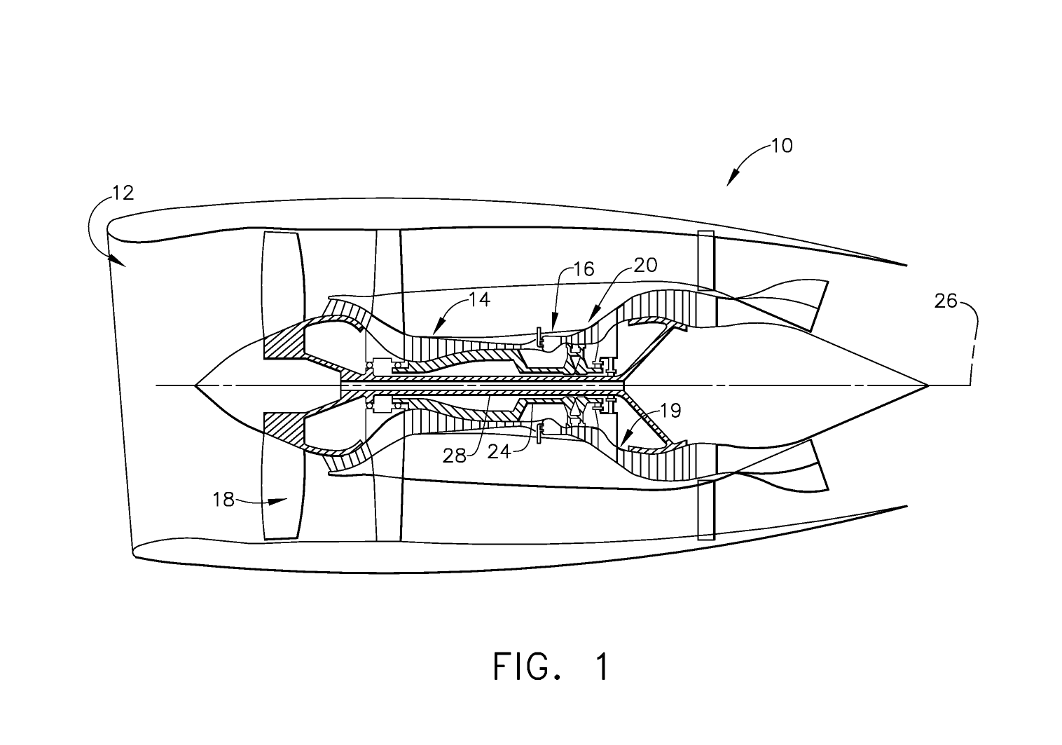

FIG. 1 is a side section view of an exemplary turbine engine.

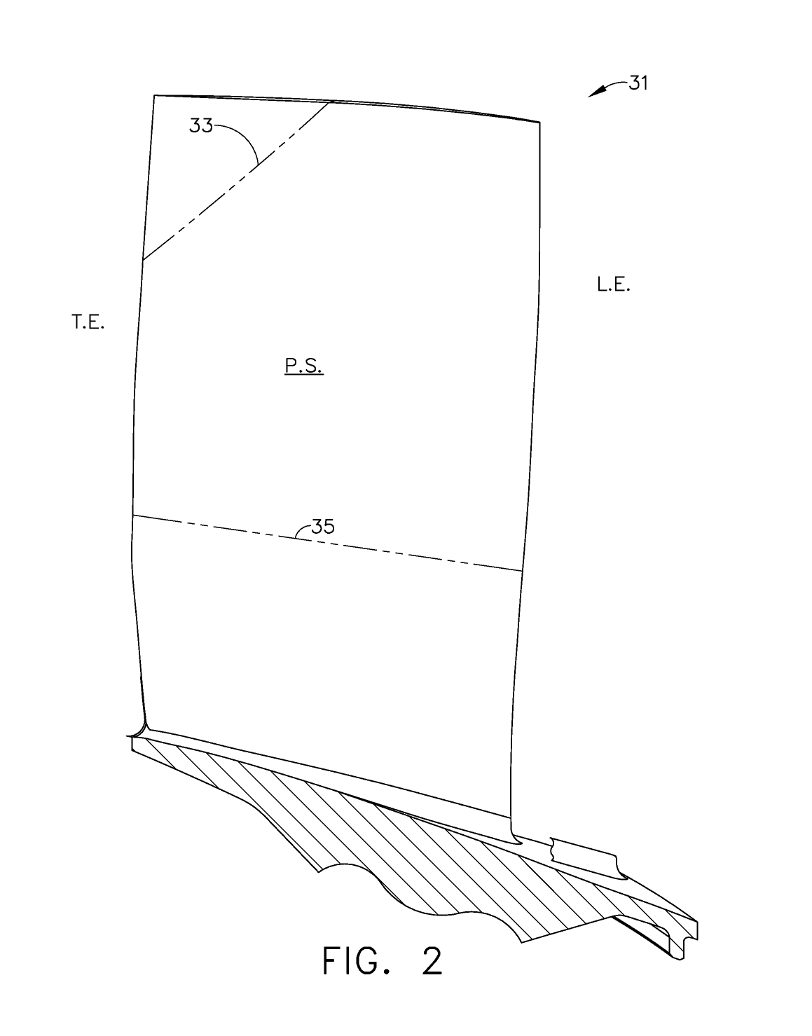

FIG. 2 is a side view of one embodiment of an engine component with exemplary weld lines.

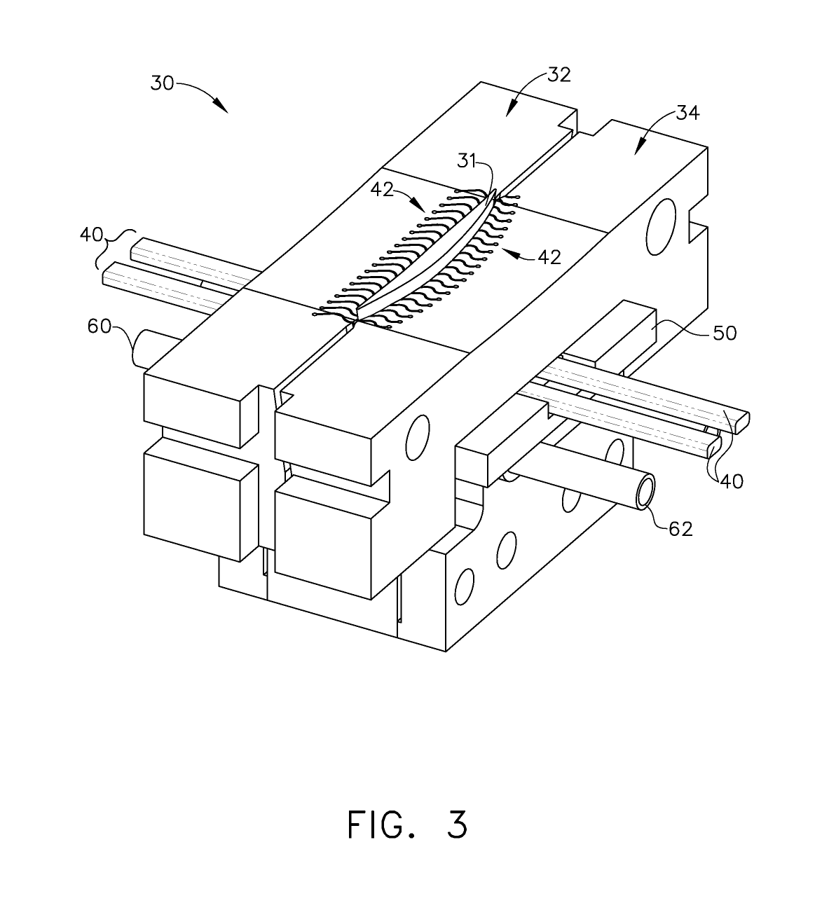

FIG. 3 is a lower perspective view of a thermal management tool.

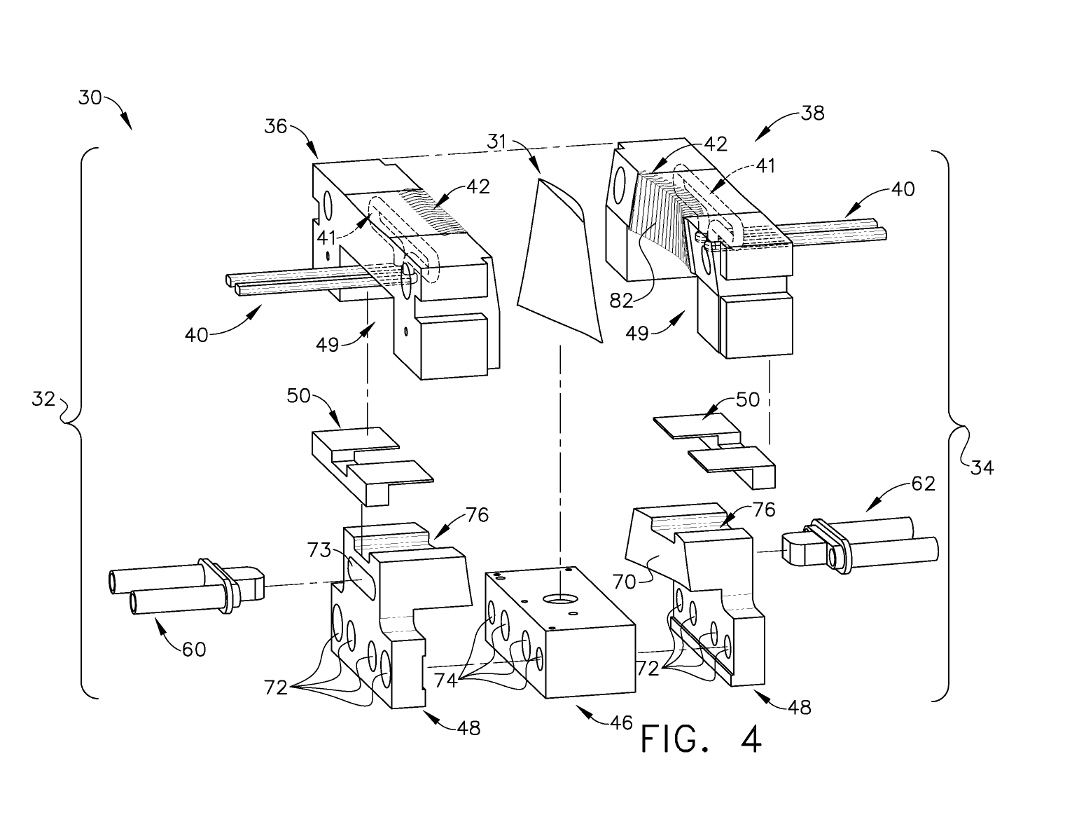

FIG. 4 is an exploded perspective view of the exemplary thermal management tool of FIG. 3.

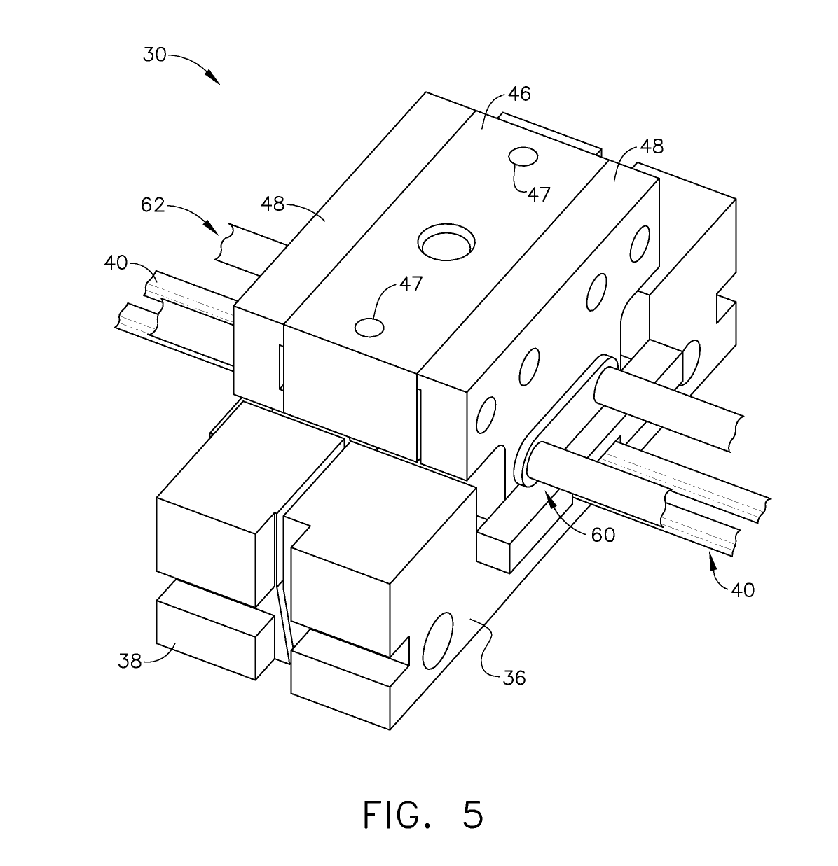

FIG. 5 is an upper perspective view of the thermal management tool of FIG. 3.

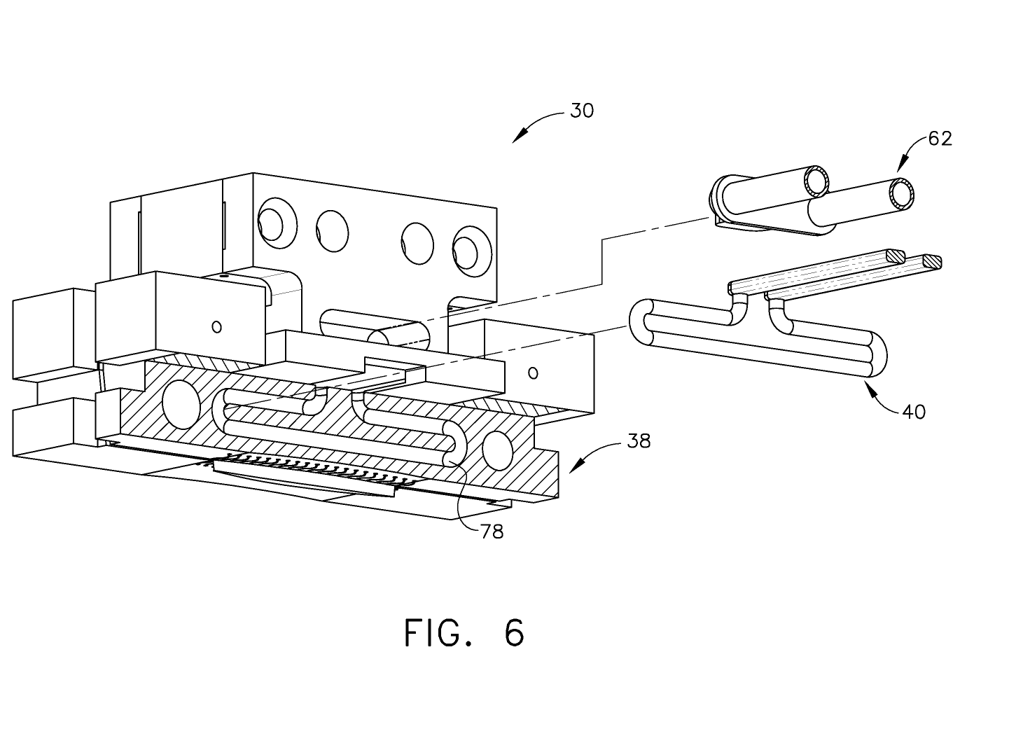

FIG. 6 is a perspective view of the exemplary thermal management tool of FIG. 3 with portions removed to depict a cavity in the tool.

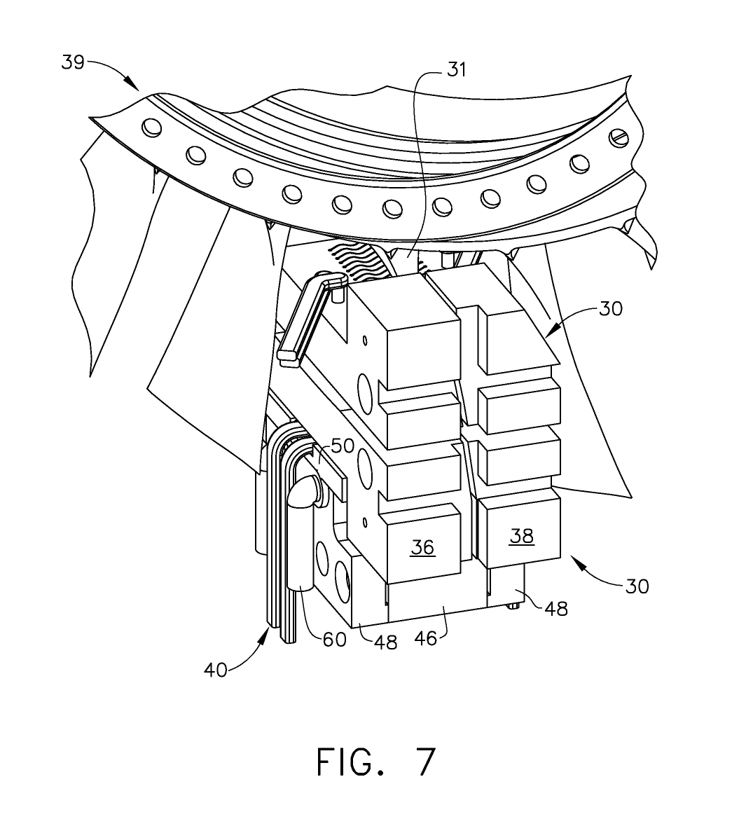

FIG. 7 is a perspective view of the thermal management tool positioned on an exemplary blisk.

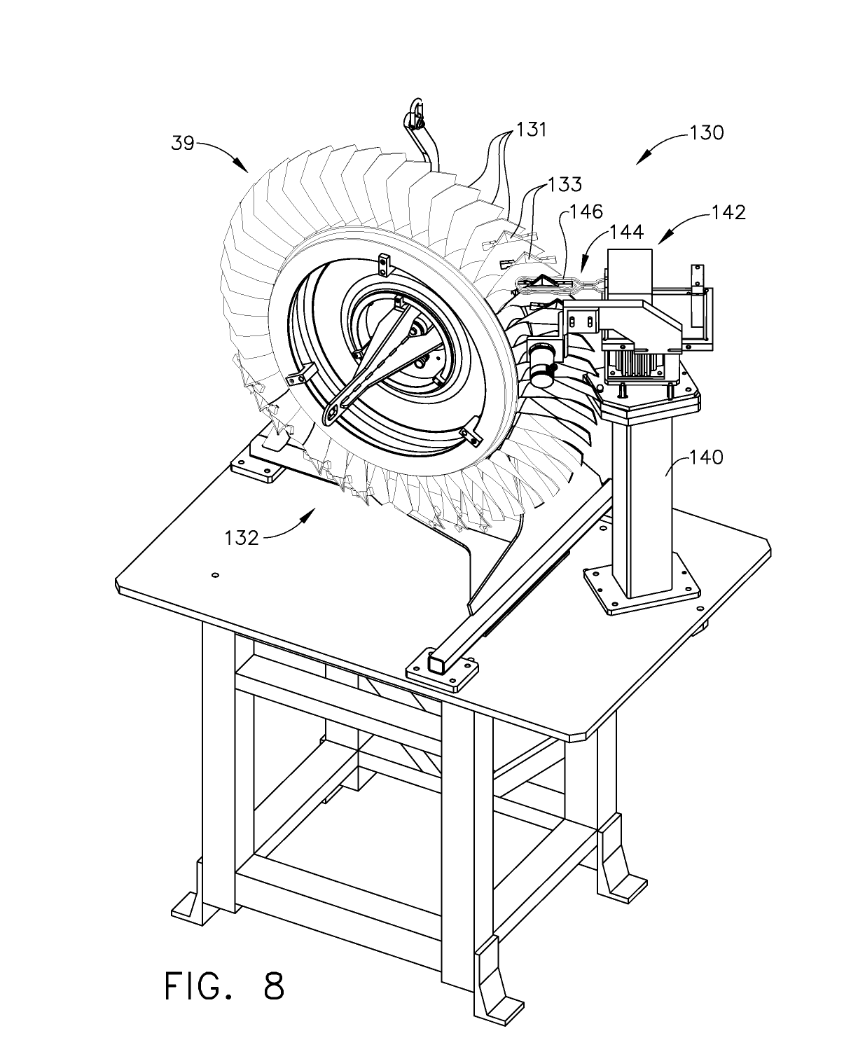

FIG. 8 is a perspective view of an alternate embodiment of a heat treatment tool.

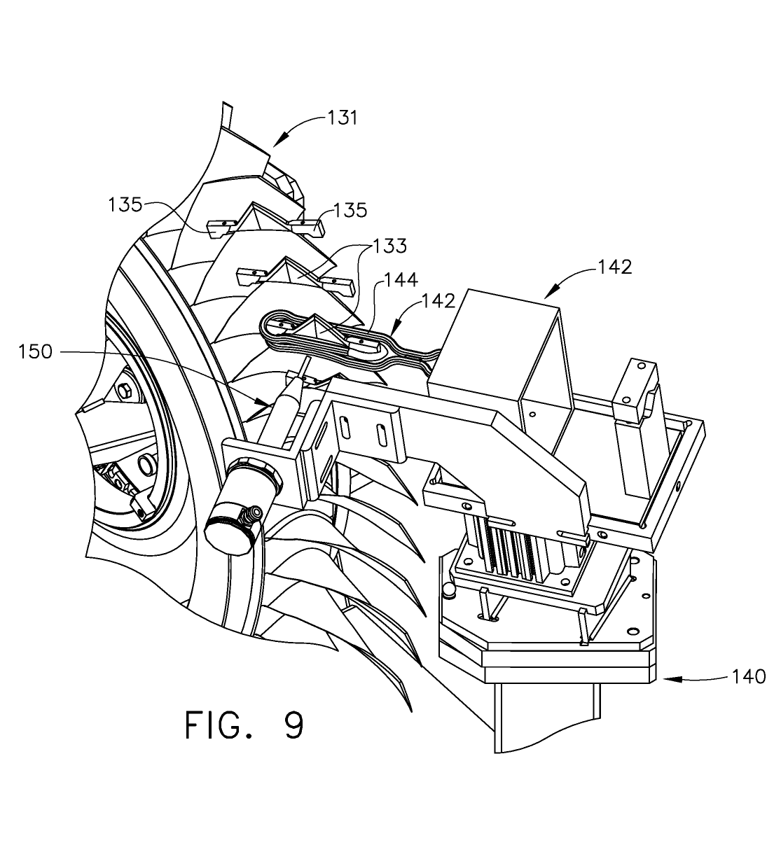

FIG. 9 is a detail perspective view of the heat treatment tool of the embodiment of FIG. 8.

### DETAILED DESCRIPTION

Reference now will be made in detail to embodiments provided, one or more examples of which are illustrated in the drawings. Each example is provided by way of explanation, not limitation of the disclosed embodiments. In fact, it will be apparent to those skilled in the art that various modifications and variations can be made in the present embodiments without departing from the scope or spirit of the disclosure. For instance, features illustrated or described as part of one embodiment can be used with another embodiment to still yield further embodiments. Thus it is intended that the present invention covers such modifications and variations as come within the scope of the appended claims and their equivalents.

Referring to FIGS. 1-9, various embodiments of a local heat treatment and thermal management system are shown in various views. The thermal management system allows the cooling rate to be controlled following a solid state resistance weld to avoid placing the entire workpiece through a thermal cycle. The thermal management system slows the cooling rate of a work piece to provide optimum microstructure and mechanical properties in the repaired airfoil while inhibiting heat transfer through the remainder of the work piece. The localized heat treatment process and apparatuses provide for heat treatment at localized locations.

As used herein, the terms “axial” or “axially” refer to a dimension along a longitudinal axis of an engine. The term “forward” used in conjunction with “axial” or “axially” refers to moving in a direction toward the engine inlet, or a component being relatively closer to the engine inlet as compared to another component. The term “aft” used in conjunction with “axial” or “axially” refers to moving in a direction toward the engine nozzle, or a component being relatively closer to the engine nozzle as compared to another component.

As used herein, the terms “radial” or “radially” refer to a dimension extending between a center longitudinal axis of the engine and an outer engine circumference. The use of the terms “proximal” or “proximally,” either by themselves or in conjunction with the terms “radial” or “radially,” refers to moving in a direction toward the center longitudinal axis, or a component being relatively closer to the center longitudinal axis as compared to another component. The use of the terms “distal” or “distally,” either by themselves or in conjunction with the terms “radial” or “radially,” refers to moving in a direction toward the outer engine circumference, or a component being relatively closer to the outer engine circumference as compared to another component.

Referring initially to FIG. 1, a schematic side section view of a gas turbine engine 10 is shown having an engine inlet end 12 wherein air enters the propulsor which is defined generally by a compressor 14, a combustor 16 and a multi-stage high pressure turbine 20. Collectively, the propulsor provides thrust or power during operation. The gas turbine 10 may be used for aviation, power generation, industrial, marine or the like. Depending on the usage, the engine inlet end 12 may alternatively contain multi-stage compressors rather than a fan. The gas turbine 10 is axis-symmetrical about engine axis 26 or shaft 24 so that various engine components rotate thereabout. In operation air enters through the air inlet end 12 of the engine 10 and moves through at least one stage of compression where the air pressure is increased and directed to the combustor 16. The compressed air is mixed with fuel and burned providing the hot combustion gas which exits the combustor 16 toward the high pressure turbine 20. At the high pressure turbine 20, energy is extracted from the hot combustion gas causing rotation of turbine blades which in turn cause rotation of the shaft 24. The shaft 24 passes toward the front of the engine to continue rotation of the one or more compressor stages 14, a turbofan 18 or inlet fan blades, depending on the turbine design.

The axis-symmetrical shaft 24 extends through the through the turbine engine 10, from the forward end to an aft end. The shaft 24 is supported by bearings along its length. The shaft 24 may be hollow to allow rotation of a low pressure turbine shaft 28 therein. Both shafts 24, 28 may rotate about the centerline axis 26 of the engine. During operation the shafts 24, 28 rotate along with other structures connected to the shafts such as the rotor assemblies of the turbine 20 and compressor 14 in order to create power or thrust depending on the area of use, for example power, industrial or aviation.

Referring still to FIG. 1, the inlet 12 includes a turbofan 18 which has a plurality of blades. The turbofan 18 is connected by the shaft 28 to the low pressure turbine 19 and creates thrust for the turbine engine 10. The low pressure air may be used to aid in cooling components of the engine as well.

Referring now to FIG. 2 a side view of an exemplary engine component or workpiece 31. The exemplary component is depicted as a blade or airfoil. The blade is shown having a leading edge LE, trailing edge TE and a surface which is a pressure side or a suction side extending therebetween. The other of the pressure and suction side is not shown in this view. The component 31 is shown with two lines extending along a surface. A first oblique line 33 is depicted at about forty five degrees (45°) which indicates wear of the trailing edge and tip of a blade. This line 33 therefore depicts a small tip portion of a component 31 which may be removed and replaced by welding and wherein the thermal management embodiments may be utilized. Further, once the blade tip or blade portion is replaced, a heat treatment process may be utilized wherein stress is relieved in the blade weld area. A second horizontal line 35 extends between the leading and trailing edge. This second horizontal line also depicts a line along which a damaged blade may be cut for replacement with a new blade portion segment. According to this embodiment, a radially outer half is replaced by welding a replacement portion on. Subsequent to the cutting and removal of the damaged portion, a new portion is welded onto the remaining portion of the blade through conventional fusion welding or solid state resistance welding (SSRW). If SSRW is utilized, the thermal management tool 30 may be utilized. Following conventional fusion welding or SSRW, the blade and weld may be locally heat treated in a subsequent step.

Referring now to FIG. 3, a lower perspective view of a SSRW heat treatment tool 30 is depicted. In should be noted that while the term lower is used, the tool 30 may be disposed in various orientations depending on how a workpiece 31 is mounted and to which the tool 30 is being connected. The tool 30 generally comprises a first workpiece receiving section 32 and a second workpiece receiving section 34. These sections 32, 34 come together to hold a portion of the workpiece 31. A second tool (not shown) retains the alternate portion of the workpiece, to which workpiece 31 is being joined. According to the non-limiting example depicted in the figure, the workpiece is a blade or airfoil which may be utilized in a blisk or mechanically attached blade for a disk or drum. Various alternate types of workpieces may be utilized with the heat treatment tool 30. For example, blisks, fan blades, fan blisks, turbine blades and vanes, cases, frames, rotating spacers and seals may all be utilized. The workpiece receiving sections 32, 34 may be changed in shape to receive the parts of varying shapes in order to properly work and apply heat to the workpieces. The tool 30 will hold one workpiece 31 and an adjacent workpiece is held by a second tool so that the two tools may be held in adjacent position, for example by a fixture, during the welding and heat treatment process.

The workpiece may be various types of engine components. For purpose of explanation, an airfoil or blade is shown in the instant embodiment. However, this should not be considered a limiting shape for a workpiece. The blade may include a pressure side and a suction side extending between leading and trailing edges of the airfoil.

Each of the first workpiece receiving section 32 in the second workpiece receiving section 34 includes a resistance heating element 40 extending into the sections 32, 34. A plurality of slits 42 also define a portion of a welding electrode and are depicted along the upper electrode surface of the tool 30 which are utilized to provide uniform clamping pressure, electrical current flow, and heat sinking for welding as will be described further herein. The heating elements 40 provide supplemental preheating, post heating or both to control the cooling rate of the workpiece following the weld process. This also allows for more controlled heating and cooling of selected locations in a localized manner as opposed to heating an entire workpiece.

Adjacent the resistive heating element 40 is a layer of insulation 50 for the tool 30. The insulation 50 limits heat transfer through the tool 30 thus aiding to localize the heat treatment. The insulation 50 also separates the welding electrode portions of 36, 38 from the clamps 48 so that the clamps 48 are not electrified and do not bond to the blocks 36, 38. Finally, the insulation separates the heated portion of the tool 30 from the cooled portion of the tool.

Extending into each of the workpiece receiving sections 32, 34 are pairs of fluid cooling tubes 60, 62. The tubes 60, 62 are in fluid communication with a portion of the tool 30. For example, according to one embodiment, the tubes 60, 62 are press fit into two sides of the tool 30. Specifically, the tubes 60, 62 are positioned in the sockets 73 (FIG. 4). Within this socket the passes into the tool and then passes back out through the tube 60 of the pair. The same process occurs in tube pair 62. The tubes 60, 62 may be filled with various types of fluid including but not limited to a shielding inert gases or liquids such as cooling water or other thermal management fluids. The fluid cooling tubes 60, 62 maintain temperatures of cooled portions of the tool at preselected temperatures or within temperature ranges as a further means of managing thermal conditions. Like the insulation 50, the cooling tubes 60, 62 helps to inhibit the spread of heat through the tool 30 and therefore aid to localize the heat treatment. Additionally, the cooling fluid aids to reduces the rate of cooling. For example, by increasing or reducing the rate of fluid movement, with rate of cooling of the workpiece may also be adjusted. This cooled portion of the tool 30 is spaced from the weld and is in contact with the workpiece 31 to cool this portion of the workpiece and inhibit spread of heat through the remainder of the workpiece and beyond, for example to a disk.

Referring now to FIG. 4, an exploded a perspective view of the heat treatment tool 30 is depicted. In this exploded view, the components of the tool 30 may be more easily explained. The first workpiece receiving section 32 includes a first heater block 36 which is retained in position against the workpiece 31 along the mounting block 46. The heater blocks 36, 38 are generally U-shaped and inverted to receive cooling clamps 48. The heater blocks 36, 38 have two functions. First the parts act as electrodes during welding of workpieces 31. Second, the heater blocks 36, 38 also are used to pre-heat or post heat the welded workpiece so as to control cooling rate of the workpiece.

Each cooling clamp 48 retains the first heater 36 in position relative to the mounting block 46. The clamps 48 are positioned through a channel 49 of the first and second heaters 36, 38 and may be connected and aligned with the mounting block 46. Each of the clamp structures 48 has a curved surface 70 to approximate the workpiece 31 surface and conform thereto. In the present embodiment, the workpiece 31 is shown as an airfoil. Accordingly, the curved surface 70 of the clamps 48 which engages the workpiece 31 approximates either the pressure side or the suction side of the exemplary airfoil. However, other engine components or workpieces 31 may be utilized in accordance with the instant disclosure. The curved surface 70 may be formed of a heat resistant material.

As depicted in the figures, the slits 42 extend in from the lower surface of the first and second electrodes 36, 38 and continue upwardly along contoured surfaces 82 to the top of the heater blocks 36, 38. The slits 42 allow for the metal heater blocks 36, 38 to conform to the shape of the workpiece 31 and further allow for the heating and cooling process, expansion and contraction, that occurs. The surface 82 is contoured to provide a work surface against which the workpiece engages. The surface 82 may be formed of hardened or heat resistant material. Without the contour allowed by the slits 42 the entire surface of the workpiece 31 would not be in contact with the heater blocks 36, 38. The slits 42 also retain electrical leads which provide the welding heat necessary for SSRW joining two portions of workpieces 31. The leads disposed within the slits 42 extending through this area provide localized heating in the area where the treatment is to occur. The slits 42 area of the blocks 36, 38 provide welding heat for the joining parts. Additionally, slit areas also may be used to slow the cooling by providing pulse-type current to the part in order to slow cooling.

Each of the clamps 48 includes a plurality of alignment apertures 72 which align with aperture 74 in the mounting block 46. Dowels, rods, fasteners or other such structure maybe position through these apertures to retain the clamp together with the mounting block and intern retain the first and second heater blocks 36, 38 together against the workpiece.

The first and second heater blocks 36, 38 also provide a cavity 78 (FIG. 6) for the resistance heaters 40. The heat elements 41 are shown in broken line and are positioned within the cavities on the interior of the heaters 36, 38. The resistance heaters 40 generally extend from the outboard side of the heater blocks 36, 38 inwardly through channels 49 and upwardly into the blocks 36, 38 forming a loop heat element 41. The loops 41 provide heat for the thermal management of the workpiece 31. The heaters 40 may be used to preheat, before welding, or post heat the workpiece 31. The post heating process occurs in order to slow the rate of cooling and may be accomplished with the embedded resistance heaters 40 used in conjunction with the welding machine power supply that can applies a controlled lower level of current flow through the welding electrodes 36 immediately following the conclusion of the weld that is made at much higher current. For example, the welding electrodes at slits 42 may be pulsed at lower current level than necessary for welding to during a period of time to reduce the are of cooling. This may be done in addition to or separately of the heater electrodes 40 to control rate of cooling. Thus the resistance wires 40 may receive current to heat the block slowing cooling process from a secondary power source not related to the resistance welding machine. Cooling rate of the welded workpiece 31 may be as high as about 2000 degrees F. per second. For some alloys, it would be desirable to reduce this rate to less than approximately 50-70 degrees F. per second within the approximately 2000 F and 1500 F range, and more specifically the 2000° F. and about 1700° F. The resistance heaters 40 extend outward and through a channel 76 in the upper portion of clamps 48 and may turn as shown in FIG. 6 to clear adjacent blades of a blisk or drum.

An insulation element or insulator 50 is positioned above the clamp 48 between the cooling clamps 48 and the heater blocks 36, 38. The insulation 50 inhibits the heaters 40, blocks 36, 38 from heating the clamps 48 in an undesirable manner. Thus the heat is limited to the heater blocks 36, 38 and the local area of the workpiece 31 so that the localized heating solely affects the workpiece. Moreover, the heat of the heater blocks 36,38 is limited from passing to the clamps 48 which are cooling the adjacent portions of the workpiece 31.

The fluid cooling tubes 60, 62 are depicted extending through into the clamps 48 through sockets 73 the clamp structure 48. The fluid cooling tubes provide a means of thermal management for the tool 30. Fluids such as liquid or gas form may be utilized to communicate with the clamps 48. The cooling inhibits the heater blocks 36, 38 from heating the cooling clamps 48. With the clamps staying cooler, the heat from the heater blocks 36, 38 is inhibited from metallurgically changing the portions of the workpiece 31 adjacent to where the welding is occurring.

Referring now to FIG. 5, an upper perspective view of the tool 30 is depicted. The tool 30 is shown from the bottom and in and assembled condition to depict the engagement of the ends 36, 38 with the mounting block 46. A plurality of apertures 47 are located in the mounting block 46 which allow the force to be applied to the workpiece 31 (FIG. 3) so that the portions of workpiece can be welded together. The weld occurs, as one skilled in the art will understand, by application of force and heat.

Referring now to FIG. 6, a perspective view of the tool 30 is depicted. The tool is shown with the fluid cooling tubes 60 and the resistance heaters 40 exploded. The cooling fluid tube is removed and the resistive heater is removed revealing a cavity 78 within the second end 38 which allows heating of the second end portion of the tool 30. Although one cavity shape is shown, alternate shapes may be utilized. This will be partially dependent upon the shape of the heater blocks 36, 38 which is dependent upon the shape of the workpiece.

Referring now to FIG. 7, a perspective view of the tool 30 is shown in position on a disk. This may be a blisk or a disk 39 with mechanically attached blades. The heater blocks 36, 38, the clamps 48 and the mounting block 46 are positioned about a workpiece or component 31 being welded. Additionally, during the weld process, the heat is limited from dissipating through the unheated portion of the workpiece. The cooling tubes 60 are shown extending into the tool 30 for cooling one of the clamps 48. Cooling tubes may be situated on the opposite the heater block 38. The heaters 40 are also shown extending into the heater block 36. An insulator 50 is depicted between the clamp 48 and the heater block 36. The tool 30 prevents heat from dissipating through the disk, which would damage portions of the disk requiring extremely close tolerances that would be varied if heated to the temperatures occurring in the area of the weld. As will also be noted, the assembly utilizes two tools 30. A first tool 30 is engaging a portion of engine component connected to the disk. A second tool 30 is disposed radially outwardly of the first tool and retains the replacement component being welded to the component in the first tool.

In operation, the workpiece 31 is disposed in at least one of the first heater block/electrode 36 and the second heater block 38. According to the instant embodiment, a weld seam extends about the entire workpiece so both heater blocks/electrodes are utilized so that the entire weld line may be heat treated. The heater blocks 36, 38 are positioned adjacent the mounting block 46 and cooling clamps 48. Dowels, rods, fasteners or other structure may be utilized to connect the clamps 48 to the mounting block 46, through apertures 72, 74 and retain the heater blocks 36, 38 in place. An insulator 50 is positioned between the heater blocks 36, 38 and the clamps 72.

Next, cooling tubes 60, 62 are connected to a fluid source so that a fluid may flow into the clamps 48. The fluid may be liquid or gas and keeps portions of the workpiece not contacting the heater blocks 36, 38 from becoming a heat sink. This limits metallurgical change in unwelded portions of the workpiece 39 and the disk 39.

When the tool 30 is constructed, with the workpiece, a resistance heater 40 is activated. The cooling fluid serves two functions. The fluid keeps the workpiece 31 cooler in areas not directly being heated. Additionally, the cooling fluid inhibits the unheated portions of the workpiece, as well as other pieces such as the blisk or disk from becoming a heat sink. The rate of cooling is slowed so that the heat treatment does not adversely affect those components of the workpiece. The cooling rate may additionally be slowed by heating the resistors 40, or by passing current through the welding electrodes 42, or both after the welding process is complete, thus preventing the workpiece from cooling too quickly.

Referring now to FIG. 8, a heat treatment station 130 is shown in perspective view. In the instant embodiment, the bladed disk 39 is shown mounted in a fixture 132. The blades or workpieces 131 extend from the central hub and as with previously embodiments may be formed with the disk or may be mechanically attached.

Adjacent to the fixture 132, the station 130 includes a mount 140. The mount 140 extends upwardly but may extend in various directions as well. At the top of the mount 140, an induction heat station 142 is positioned. The station 142 includes an induction coil 144 extending outwardly. The coils 144 form a loop 146 wherein a tip of the blades 131 is positioned.

As mentioned with reference to FIG. 2, the blades may be welded in large portions for example, or at the tip as indicated at line 33. This latter example is depicted but is non-limiting as other examples may be provided. Referring again to FIG. 8, the tips of the blades 131 are mostly removed. However, closest to the induction coils 144, the tips are shown welded in position for purpose of explanation.

Once the blade tips 133 are disposed on the blades 131, these weld lines must be heat treated. The heat treatment provides for stress relief of the blade. The localized heat treatment however is desirable in order to inhibit buildup of oxidation or alpha case to only the weld repaired area of the entire part. For example, with titanium based materials, the heat treatment may cause alpha case build up on the metal as previously described and which must be removed before service.

The heat treatment station 130 allows for selected heat treatment of the specific weld area of the blade at the joint with the weld tip 133. In this manner, the entirety of the blade 131 need not be heat treated. Instead, the portion of the blade needing stress relief, i.e. the weld repaired area, can be heat treated. Additionally, the side effects of the heat treating process do not affect remainder of the blade and disk.

Referring now to FIG. 9, a detail perspective of the coil 144 is shown with the tip 133 passing through the induction coil 144. The internally water cooled coil is formed of a conductive metal, such as copper, for example. The process involves circulating alternating current to create an intense magnetic field within the space enclosed by the coil 144. The eddy current from the magnetic field are within the workpiece 131 and the direction of the currents is opposite the resistivity of the metal workpiece 131. As a result, only the workpiece 131 will get hot and the closer the coil to the workpiece 131, the higher the temperature may be. Due to the thin material thickness build of the workpieces 131, the induction heat treatment process is well suited to stress relief. As shown adjacent tips 133, the components 131 further comprise tabs 135 which provide extra material for run on and run off during the welding process. The tabs 135 may provide heat sinking during welding, but not during local heat treatment. The temperatures in this process are generally less than those of the weld process involving the thermal management process previously described.

Also shown in FIG. 9 is a pyrometer 150 for closed loop temperature control. The pyrometer 150 may be an infrared spot pyrometer which detects a temperature of the component 131 disposed within the coil 144. In this manner, the temperature may be monitored and data fed back to a programmable controller to determine the appropriate ramp up and ramp down, heating rate, heating temperature and time, holding, cool down rate and stopping. This automatically controls the stress relief has occurred in the welded engine component. With the closed loop system, the temperature and time are controlled for proper heat treatment.

The foregoing description of structures and methods has been presented for purposes of illustration. It is not intended to be exhaustive or to limit the invention to the precise steps and/or forms disclosed, and obviously many modifications and variations are possible in light of the above teaching. Features described herein may be combined in any combination. Steps of a method described herein may be performed in any sequence that is physically possible. It is understood that while certain forms of a local heat treatment process and apparatus have been illustrated and described, it is not limited thereto and instead will only be limited by the claims, appended hereto.

While multiple inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Examples are used to disclose the embodiments, including the best mode, and also to enable any person skilled in the art to practice the apparatus and/or method, including making and using any devices or systems and performing any incorporated methods. These examples are not intended to be exhaustive or to limit the disclosure to the precise steps and/or forms disclosed, and many modifications and variations are possible in light of the above teaching. Features described herein may be combined in any combination. Steps of a method described herein may be performed in any sequence that is physically possible.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claims is:

1. A method of heat treating an engine component, comprising:
welding a first portion of an engine compartment on a second portion of said first portion of said engine component;
positioning said engine component in a fixture at a heat treatment station;
positioning at least one of said first portion and said second portion in an induction coil;
applying current to said coil; and,
heat treating said at least one of said first portion and said second portion.

2. The method of claim 1 wherein said engine component is a blade tip.

3. The method of claim 1 wherein said engine component is a blade segment.

4. The method of claim 1 further comprising controlling the temperature of the induction coil.

5. The method of claim 4 said controlling including aiming a pyrometer at said engine component.

6. The method of claim 5, directing an infrared beam at said engine component.

7. The method of claim 6 further comprising feedback loop to provide a temperature reading to a controller.

8. The method of claim 7 further comprising automated starting, ramping, holding, and stopping of said heat treating of said engine component.

9. The method of claim 1 further comprising rotating said fixture.

10. The method of claim 9 further comprising engaging a subsequent engine component with said induction coil.

11. A method of heat treating an engine component, comprising:
connecting a disk having a plurality of titanium components to a fixture;
positioning one of said titanium components into an induction coil loop;
providing an alternating current to said induction coil loop;
heat treating said titanium component positioned in said induction coil loop; and,
monitoring a temperature of said heat treating.

12. The method of claim 11 further comprising ending said heat treating based on a temperature reading of said monitoring.

13. The method of claim 11 further comprising mounting a pyrometer on said fixture.

14. The method of claim 13 further comprising controlling various aspects of the heat treatment with said pyrometer and a controller.
